(19) United States
(12) Patent Application Publication
(10) Pub. No.: US 2025/0240043 A1
(43) Pub. Date: Jul. 24, 2025

(54) WAKE-UP RECEIVER

(71) Applicant: University of Science and Technology of China, Anhui (CN)

(72) Inventors: Chengjie ZUO, Anhui (CN); Jingsong LIU, Anhui (CN); Fuhong LIN, Anhui (CN); Jialin LONG, Anhui (CN); Feng WU, Anhui (CN)

(21) Appl. No.: 18/853,685

(22) PCT Filed: Apr. 2, 2022
(86) PCT No.: PCT/CN2022/084984

§ 371 Date: Oct. 2, 2024

(51) Int. Cl. H04B 1/16; H04B 1/10; H04W 52/02

(52) U.S. Cl. CPC H04B 1/1615; H04B 1/10; H04W 52/0238

(57) ABSTRACT

The present disclosure provides a wake-up receiver, including: a radio frequency filter configured to filter a composite signal including an input signal and a background noise signal to obtain a first filtered signal, the first filtered signal includes the input signal and a part of the background noise signal, and the input signal is a product of a modulated signal and a radio frequency carrier; a self-mixing oscillator connected to the radio frequency filter and configured to cause the first filtered signal to self-mix to obtain a mixed signal; an intermediate frequency filter connected to the self-mixing oscillator and configured to filter the mixed signal, so as to filter out the noise self-mixed signal in the mixed signal and obtain a second filtered signal, the second filtered signal includes the modulated signal; and a wake-up signal generation module connected to the intermediate frequency filter and configured to obtain a wake-up signal according to the modulated signal.

### TECHNICAL FIELD

The present disclosure relates to a field of radio frequency wireless communications, and in particular, to a wake-up receiver.

### BACKGROUND

The wake-up receiver may monitor a channel with extremely low power consumption. When the wake-up receiver receives a wake-up signal, it wakes up a main receiver, thereby reducing a standby power consumption of a wireless communication system.

With the development of wireless communication technology, frequency bands where the wake-up receiver works such as those for WiFi, Bluetooth. and ISM have become increasingly crowded. There is strong background noise in the environment, and the current wake-up receiver architecture is difficult to effectively suppress the background noise. This is because, on the one hand, the matching network of the wake-up receiver is usually based on piezoelectric resonators such as off-chip inductors and capacitors or film bulk acoustic resonators (FBARs), and the quality factor (i.e., Q value) (Q value of off-chip inductor <100, Q value of FBAR is less than 2000) of the piezoelectric resonator determines that the radio frequency bandwidth is higher than 1 MHz. This causes the total power of the background noise in the passband to far exceed the total power of the signal. On the other hand, the signal modulation method of on-off keying (OOK) adopted by the wake-up receiver makes the system down-converted output signal a DC signal. When the total amount of background noise in the passband exceeds the signal power, the down-converted output signal will be shielded by the output generated by the noise.

### SUMMARY

One aspect of the present disclosure provides a wake-up receiver, including:

a radio frequency filter configured to filter a composite signal including an input signal and a background noise signal to obtain a first filtered signal, wherein the first filtered signal includes the input signal and a part of the background noise signal, and the input signal is a product of a modulating signal and a radio frequency carrier;

a self-mixing oscillator connected to the radio frequency filter and configured to cause the first filtered signal to self-mix to obtain a mixed signal, wherein the mixed signal includes a modulated signal obtained by self-mixing the input signal, a noise self-mixed signal obtained by self-mixing the part of the background noise signal, and a signal-noise mixed signal obtained by mixing the input signal with the part of the background noise signal;

an intermediate frequency filter connected to the self-mixing oscillator and configured to filter the mixed signal, so as to filter out the noise self-mixed signal in the mixed signal and obtain a second filtered signal, wherein the second filtered signal includes the modulated signal; and

a wake-up signal generation module connected to the intermediate frequency filter and configured to obtain a wake-up signal according to the modulated signal;

wherein a frequency of the modulated signal is greater than or equal to a radio frequency passband bandwidth of the radio frequency filter.

Optionally, an output bandwidth of the self-mixing oscillator is greater than or equal to the radio frequency passband bandwidth of the radio frequency filter.

Optionally, the modulated signal is a product of a binary signal and an intermediate frequency carrier signal with a frequency of f_{IF}, and a frequency of the modulated signal is f_{IF}.

Optionally, the intermediate frequency filter is further configured to filter a baseband thermal noise signal generated by the wake-up receiver to obtain a part of the baseband thermal noise signal.

Optionally, the wake-up signal generation module includes:

a baseband low noise amplifier configured to amplify the modulated signal to obtain an amplified signal;

an analog-to-digital converter configured to perform an analog-to-digital conversion on the amplified signal to obtain a digital signal; and

a correlator configured to decode the digital signal to obtain a binary signal, and issue a wake-up instruction when the binary signal is identified as the wake-up signal.

Optionally, the radio frequency filter includes a first resonator, and a quality factor of the first resonator is greater than 16000.

Optionally, the first resonator is selected from one of a high-overtone bulk acoustic resonator, a monocrystalline piezoelectric thin film resonator, a laterally-excited overmoded bulk acoustic resonator, a piezoelectric thin film on insulator resonator, a hollow-disk resonator, and a fin waveguide resonator.

Optionally, a bandwidth of the intermediate frequency filter is less than 10 Hz.

Optionally, the intermediate frequency filter includes a second resonator, and a quality factor of the second resonator is greater than 15000.

Optionally, the second resonator is selected from one of a quartz crystal resonator, a diamond crystal resonator, a sapphire crystal resonator, a silicon carbide crystal resonator, a lithium niobate crystal resonator, and a lithium tantalate crystal resonator.

### BRIEF DESCRIPTION OF THE DRAWINGS

FIG. 1 schematically shows a block diagram of a wake-up receiver provided according to the embodiments of the present disclosure;

FIG. 2A schematically shows an internal circuit diagram of a radio frequency filter provided according to the embodiments of the present disclosure;

FIG. 2B schematically shows a two-port parameter spectrum diagram of the radio frequency filter shown in FIG. 2A;

FIG. 3 schematically shows an internal circuit diagram of an intermediate frequency filter provided according to the embodiments of the present disclosure.

FIG. 4A schematically shows a power spectrum diagram of an input signal and a background noise signal provided according to the embodiments of the present disclosure;

FIG. 4B schematically shows a power spectrum diagram of a first filtered signal output by a radio frequency filter provided according to the embodiments of the present disclosure;

FIG. 4C schematically shows a power spectrum diagram of a mixed signal output by a self-mixing oscillator provided according to the embodiments of the present disclosure;

FIG. 4D schematically shows a power spectrum diagram of a second filtered signal output by an intermediate frequency filter provided according to the embodiments of the present disclosure.

### REFERENCE SIGNS

1. radio frequency filter, 2. self-mixing oscillator, 3. intermediate frequency filter, 4. wake-up signal generation module, 5. antenna, 41. baseband low noise amplifier, 42. analog-to-digital converter, 43. correlator.

### DETAILED DESCRIPTION OF EMBODIMENTS

The following further describes the embodiments of the present disclosure in conjunction with the drawings.

FIG. 1 schematically shows a block diagram of a wake-up receiver provided according to the embodiments of the present disclosure.

As shown in FIG. 1, the wake-up receiver includes: a radio frequency filter 1, a self-mixing oscillator 2, an intermediate frequency filter 3, and a wake-up signal generation module 4.

The radio frequency filter 1 is configured to filter a composite signal including an input signal and a background noise signal to obtain a first filtered signal. The first filtered signal includes the input signal and a part of the background noise signal. The input signal is a product of a modulating signal and a radio frequency carrier, and a frequency of the radio frequency carrier is f_{RF}.

The self-mixing oscillator 2 is connected to the radio frequency filter 1 and is configured to cause the first filtered signal to self-mix. A self-mixing is performed on the input signal to obtain a modulated signal, a self-mixing is performed on the part of the background noise signal to obtain a noise self-mixed signal, and the input signal is mixed with the part of the background noise signal to obtain a signal-noise mixed signal. The self-mixing oscillator 2 is configured to output a mixed signal, and the mixed signal includes the modulated signal, the noise self-mixed signal and the signal-noise mixed signal.

The intermediate frequency filter 3 is connected to the self-mixing oscillator 2 and is configured to filter the mixed signal, so as to filter out the noise self-mixed signal in the mixed signal and obtain a second filtered signal. The second filtered signal includes the modulated signal.

The wake-up signal generation module 4 is connected to the intermediate frequency filter 3 and is configured to obtain a wake-up signal according to the modulated signal.

A frequency of the modulated signal is greater than or equal to a radio frequency passband bandwidth of the radio frequency filter 1, and the radio frequency passband bandwidth is expressed as BW_{RF}.

According to the wake-up receiver provided by the embodiments of the present disclosure, the total amount of background noise signal and other interferences in the first filtered signal obtained is greatly reduced by filtering the composite signal using the radio frequency filter 1. By setting the frequency of the modulated signal to be greater than or equal to the radio frequency passband bandwidth of the radio frequency filter 1, the noise self-mixed signal obtained after the first filtered signal is mixed by the self-mixing oscillator 2 does not overlap with the frequency band of the modulated signal, so that the noise self-mixed signal may be filtered out by the intermediate frequency filter 3.

According to the embodiments of the present disclosure, the modulated signal is a product of a binary signal and an intermediate frequency carrier signal with a frequency of f_{IF}, and the frequency of the modulated signal is f_{IF}.

According to the embodiments of the present disclosure, a wake-up sequence (binary signal) may be encoded by amplitude modulation, phase modulation or frequency modulation.

According to the embodiments of the present disclosure, the wake-up signal generation module 4 includes: a baseband low noise amplifier 41, an analog-to-digital converter 42 and a correlator 43.

The baseband low noise amplifier 41 is configured to amplify the modulated signal to obtain an amplified signal. The analog-to-digital converter 42 is configured to perform an analog-to-digital conversion on the amplified signal to obtain a digital signal. The correlator 43 is configured to decode the digital signal to obtain a decoded signal, and issue a wake-up instruction when the decoded signal is identified as the wake-up signal. The wake-up signal generation module 4 extracts the decoded signal of the 01 sequence from the modulated signal in the second filtered signal output by the intermediate frequency filter 3, so as to determine whether to issue the wake-up instruction. The baseband low noise amplifier 41 is set after the intermediate frequency filter 3, so that the mixed signal is first processed by the intermediate frequency filter 3 and then enters the baseband low noise amplifier 41 for processing. This is because the noise coefficient of the intermediate frequency filter 3 is better, thereby optimizing the performance of the wake-up receiver system.

According to the embodiments of the present disclosure, the radio frequency filter 1 includes a first resonator, and the quality factor of the first resonator is greater than 16000. Therefore, the first resonator is also called a high-Q RF micro-electromechanical resonator. The radio frequency filter 1 based on the high-Q RF micro-electromechanical resonator and other radio frequency components may achieve an radio frequency bandwidth of less than 150 kHz. The first resonator is selected from one of a high-overtone bulk acoustic resonator, a monocrystalline piezoelectric thin film resonator, a laterally-excited overmoded bulk acoustic resonator, a piezoelectric thin film on insulator resonator, a hollow-disk resonator, and a fin waveguide resonator. The frequency of the modulated signal of the embodiments of the present disclosure is greater than or equal to the radio frequency passband bandwidth (≥150 kHz) of the radio frequency filter 1, so that the sampling rate is higher, and therefore the system wake-up speed is faster.

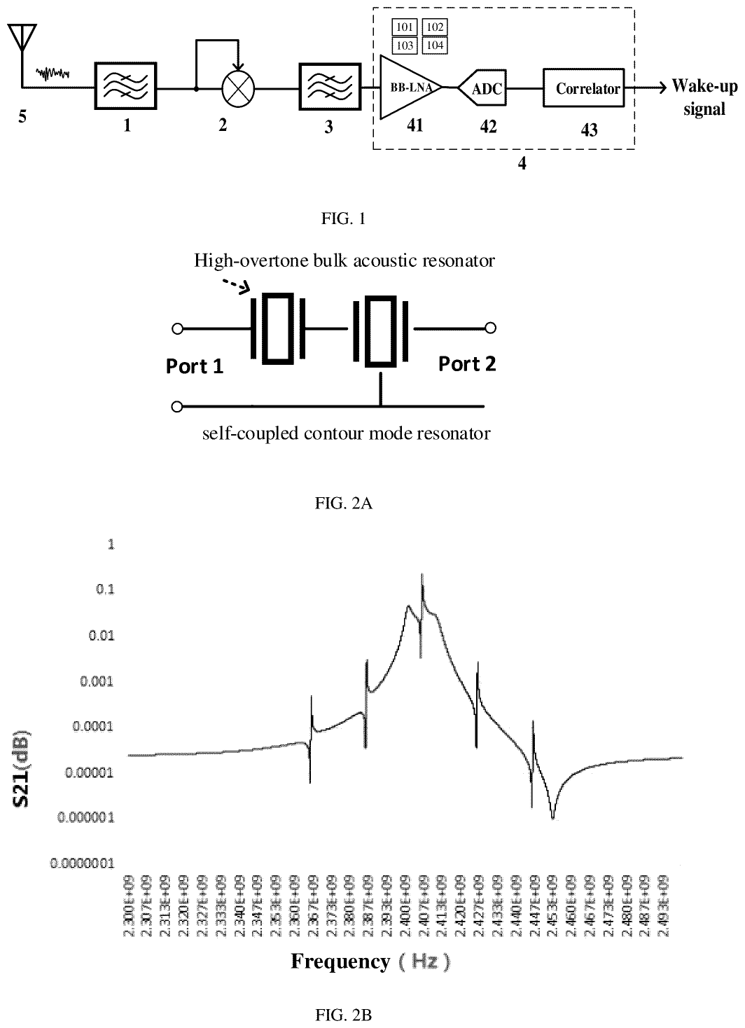

FIG. 2A schematically shows an internal circuit diagram of a radio frequency filter provided according to the embodiments of the present disclosure.

As shown in FIG. 2A, the radio frequency filter 1 includes a high-overtone bulk acoustic resonator and a self-coupled contour mode resonator. A high Q value of the high-overtone bulk acoustic resonator may reduce the overall bandwidth of the radio frequency filter 1. The high-overtone bulk acoustic resonator has several resonance peaks with equal spacing. By utilizing the single resonance peak characteristics of the self-coupled contour mode resonator, the irrelevant passband of the high-overtone bulk acoustic resonator may be filtered out, and only the passband containing the carrier frequency point of the input signal is retained, so that the radio frequency filter 1 retains only an extremely narrow radio frequency passband. The composite signal of the background noise signal and the input signal is evenly distributed in the frequency band of f_{IF}±BW_{RF}. By using the intermediate frequency filter 3 with an off-chip high-Q low-frequency resonator as the core, the intermediate frequency band of the system may be greatly reduced, thereby improving the suppression of the mixing noise of the background noise and the signal.

FIG. 2B schematically shows a two-port parameter spectrum of the radio frequency filter shown in FIG. 2A.

As shown in FIG. 2B, S21 is a two-port parameter of the radio frequency filter, and S21 represents an insertion loss. It may be seen from FIG. 2B that the radio frequency filter 1 has an extremely narrow radio frequency passband bandwidth.

According to the embodiments of the present disclosure, the output bandwidth of the self-mixing oscillator 2 is greater than or equal to the radio frequency passband bandwidth of the radio frequency filter 1, so that the modulated signal with the frequency higher than BW_{RF} may be output. After passing through the radio frequency filter, the composite signal enters the self-mixing oscillator 2 (high-speed self-mixing oscillator). The self-mixing oscillator 2 may increase the baseband bandwidth by reducing the number of mixer stages, so that the self-mixing oscillator 2 may output the modulated signal with the frequency of f_{IF} instead of a DC signal. Since reducing the number of stages of the self-mixing oscillator 2 will result in a decrease in gain, so the baseband low noise amplifier 41 is used for compensation.

According to the embodiment of the present disclosure. the bandwidth (BW_{IF}) of the intermediate frequency filter 3 is less than 10 Hz. The intermediate frequency filter 3 includes a second resonator, the second resonator is an off-chip high-Q low-frequency resonator, and the quality factor of the second resonator is greater than 15000.

According to the embodiments of the present disclosure, the second resonator is selected from one of a quartz crystal resonator, a diamond crystal resonator, a sapphire crystal resonator, a silicon carbide crystal resonator, a lithium niobate crystal resonator, and a lithium tantalate crystal resonator.

According to the embodiments of the present disclosure, the intermediate frequency filter 3 based on the off-chip high-Q low-frequency resonator may reduce the intermediate frequency bandwidth of the wake-up receiver, thereby improving the suppression of the mixing noise of the signal and the background noise signal.

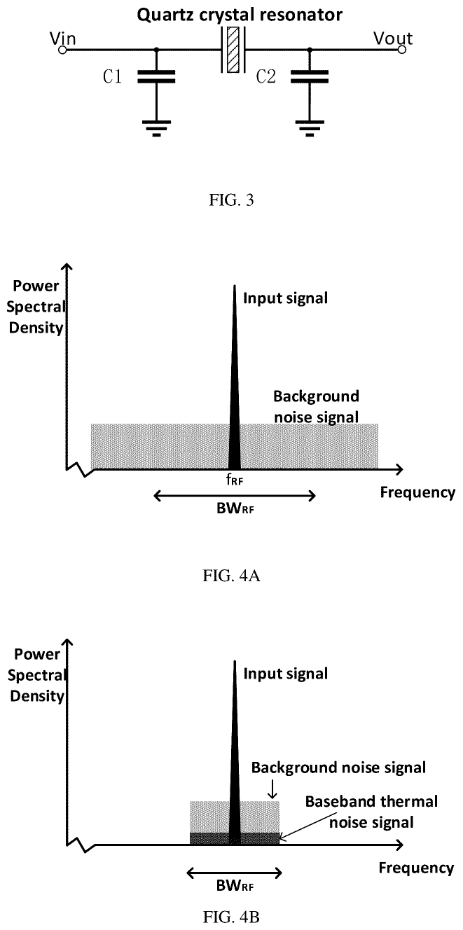

FIG. 3 schematically shows an internal circuit diagram of an intermediate frequency filter provided according to the embodiments of the present disclosure.

As shown in FIG. 3, C1 and C2 are capacitors connected in parallel to the ground at two ends of the quartz resonator. The quartz resonator may increase the high-frequency insertion loss of the intermediate frequency filter so that the intermediate frequency filter has only one passband.

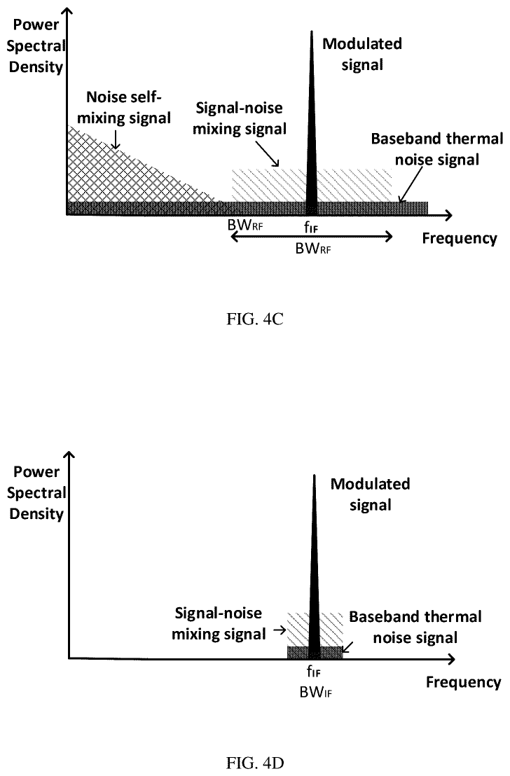

FIG. 4A schematically shows a power spectrum diagram of an input signal and a background noise signal provided according to the embodiments of the present disclosure, and FIG. 4B schematically shows a power spectrum diagram of a first filtered signal output by a radio frequency filter provided according to the embodiments of the present disclosure.

The input signal and the background noise signal of FIG. 4A are output by an antenna 5. The input signal and the background noise signal in FIG. 4A are filtered by the radio frequency filter 1 to obtain the first filtered signal. It may be seen from FIG. 4B, the total amount of background noise signal and other interference in the first filtered signal is greatly reduced compared with FIG. 4A.

In addition, it may be seen from FIG. 4B, the radio frequency filter 1 also outputs a part of baseband thermal noise signal, which is generated by the wake-up receiver.

FIG. 4C schematically shows a power spectrum diagram of a mixed signal output by a self-mixing oscillator provided according to the embodiments of the present disclosure.

As shown in FIG. 4C, the mixed signal output from the self-mixing oscillator 2 includes the modulated signal, the noise self-mixed signal, and the signal-noise mixed signal. It may be seen from FIG. 4C, the frequency band of the noise self-mixed signal and the frequency band of the modulated signal do not overlap, which is caused by setting the frequency of the modulated signal to be greater than or equal to the radio frequency passband bandwidth of the radio frequency filter. It may also be seen from FIG. 4C, the mixed signal output from the self-mixing oscillator 2 also includes the baseband thermal noise signal generated by the wake-up receiver.

FIG. 4D schematically shows a power spectrum diagram of a second filtered signal output by an intermediate frequency filter provided according to the embodiments of the present disclosure.

As shown in FIG. 4D, after the mixed signal is filtered by the intermediate frequency filter 3, the second filtered signal is obtained. The noise self-mixed signal in the second filtered signal is completely filtered out, and the power of the signal noise mixed signal and the power of the baseband thermal noise signal power are greatly reduced.

According to the wake-up receiver provided by the embodiments of the present disclosure, based on the high Q value (>16000) of the high-Q first resonator, the radio frequency passband bandwidth BW_{RF} of the radio frequency filter 1 is extremely low. After the background noise passes through the self-mixing oscillator 2, the baseband noise generated is mainly concentrated in the frequency band below BW_{RF}. When BW_{RF}<f_{IF}, the self-mixing of the background noise does not overlap with the frequency band of the intermediate frequency signal, so it may be filtered out by the intermediate frequency filter 3.

According to the wake-up receiver provided by the embodiments of the present disclosure, the signal generated by mixing the background noise signal with the input signal is evenly distributed in the frequency band of f_{IF}±BW_{RF}. By filtering with the intermediate frequency filter 3 based on the off-chip high-Q low-frequency resonator, the intermediate frequency band of the wake-up receiver system may be greatly reduced, thereby improving the suppression of the mixing noise of the background noise and the signal.

According to the wake-up receiver provided by the embodiments of the present disclosure, by filtering with the high-Q RF micro-electromechanical resonator and the intermediate frequency off-chip high-Q low-frequency resonator, and the corresponding coding rules, the wake-up receiver has a sensitivity higher than −70 dBm when the background noise is −30 dBm/MHz.

According to the wake-up receiver provided by the embodiments of the present disclosure, the three noise signals of noise self-mixed signal. signal-noise mixed signal and baseband thermal noise signal are strongly suppressed.

The specific embodiments described above further illustrate the purpose, technical solutions and beneficial effects of the present disclosure. It should be understood that the above description is only a specific embodiment of the present disclosure and is not intended to limit the present disclosure. Any modifications, equivalent substitutions, improvements, etc. made within the spirit and principles of the present disclosure should be included in the protection scope of the present disclosure.

1. A wake-up receiver, comprising:
a radio frequency filter configured to filter a composite signal comprising an input signal and a background noise signal to obtain a first filtered signal, wherein the first filtered signal comprises the input signal and a part of the background noise signal, and the input signal is a product of a modulating signal and a radio frequency carrier;
a self-mixing oscillator connected to the radio frequency filter and configured to cause the first filtered signal to self-mix to obtain a mixed signal, wherein the mixed signal comprises a modulated signal obtained by self-mixing the input signal, a noise self-mixed signal obtained by self-mixing the part of the background noise signal, and a signal-noise mixed signal obtained by mixing the input signal with the part of the background noise signal;
an intermediate frequency filter connected to the self-mixing oscillator and configured to filter the mixed signal, so as to filter out the noise self-mixed signal in the mixed signal and obtain a second filtered signal, wherein the second filtered signal comprises the modulated signal; and
a wake-up signal generation module connected to the intermediate frequency filter and configured to obtain a wake-up signal according to the modulated signal;
wherein a frequency of the modulated signal is greater than or equal to a radio frequency passband bandwidth of the radio frequency filter.

2. The wake-up receiver according to claim 1, wherein an output bandwidth of the self-mixing oscillator is greater than or equal to the radio frequency passband bandwidth of the radio frequency filter.

3. The wake-up receiver according to claim 1, wherein the modulated signal is a product of a binary signal and an intermediate frequency carrier signal with a frequency of f_{IF}, and a frequency of the modulated signal is f_{IF}.

4. The wake-up receiver according to claim 1, wherein the intermediate frequency filter is further configured to filter a baseband thermal noise signal generated by the wake-up receiver to obtain a part of the baseband thermal noise signal.

5. The wake-up receiver according to claim 1, wherein the wake-up signal generation module comprises:
a baseband low noise amplifier configured to amplify the modulated signal to obtain an amplified signal;
an analog-to-digital converter configured to perform an analog-to-digital conversion on the amplified signal to obtain a digital signal; and
a correlator configured to decode the digital signal to obtain a binary signal, and issue a wake-up instruction when the binary signal is identified as the wake-up signal.

6. The wake-up receiver of claim 1, wherein the radio frequency filter comprises a first resonator, and a quality factor of the first resonator is greater than 16000.

7. The wake-up receiver of claim 6, wherein the first resonator is selected from one of a high-overtone bulk acoustic resonator, a monocrystalline piezoelectric thin film resonator, a laterally-excited overmoded bulk acoustic resonator, a piezoelectric thin film on insulator resonator, a hollow-disk resonator, and a fin waveguide resonator.

8. The wake-up receiver according to claim 1, wherein a bandwidth of the intermediate frequency filter is less than 10 Hz.

9. The wake-up receiver according to claim 1, wherein the intermediate frequency filter comprises a second resonator, and a quality factor of the second resonator is greater than 15000.

10. The wake-up receiver according to claim 9, wherein the second resonator is selected from one of a quartz crystal resonator, a diamond crystal resonator, a sapphire crystal resonator, a silicon carbide crystal resonator, a lithium niobate crystal resonator, and a lithium tantalate crystal resonator.
